(19) United States
(12) Patent Application Publication
(10) Pub. No.: US 2023/0004220 A1
(43) Pub. Date: Jan. 5, 2023

(54) DYNAMIC UNIFORMITY COMPENSATION FOR FOVEATED IMAGING IN VIRTUAL REALITY AND AUGMENTED REALITY HEADSETS

(71) Applicant: Meta Platforms Technologies, LLC, Menlo Park, CA (US)

(72) Inventors: Shuang Wang, Palo Alto, CA (US); Edward Buckley, Redmond, WA (US)

(21) Appl. No.: 17/845,598

(22) Filed: Jun. 21, 2022

Related U.S. Application Data
(60) Provisional application No. 63/217,608, filed on Jul. 1, 2021.

(51) Int. Cl. G06F 3/01; G06T 19/00; G02B 27/01

(52) U.S. Cl. CPC G06F 3/013; G06T 19/003; G06T 19/006; G02B 27/017

(57) ABSTRACT

A method for dynamic uniformity compensation in displays for virtual reality and augmented reality headsets is provided. The method includes identifying an eyeball position within an image frame in a display, forming a filter for the two-dimensional array, centered on the eyeball position within the image frame. The method also includes collecting a calibration frame for the two-dimensional array indicative of a uniformity map for pupil locations, generating a filtered map associated with the eyeball position within the image frame, using the filter for the two-dimensional array and the calibration frame, obtaining a uniformity correction factor for a pixel in the display corresponding to the eyeball position within the image frame, based on the filtered map, and generating eyeball uniformity maps including uniformity correction factors for display pixels. A system and a memory storing instructions to cause the system to perform the above method are also provided.

### CROSS-REFERENCE TO RELATED APPLICATIONS

The present disclosure is related and claims priority under 35 USC. § 119(e) to US Prov. Pat. Appin. No. 63/217,608, entitled DYNAMIC UNIFORMITY COMPENSATION FOR FOVEATED IMAGING IN VIRTUAL REALITY AND AUGMENTED REALITY HEADSETS, filed on Jul. 1, 2021, to Shuang WANG et-al., the contents of which applications are hereby incorporated herein by reference in their entirety, for all purposes.

### BACKGROUND

### Field

The present disclosure is related to foveated imaging in virtual reality (VR) and augmented reality (AR) headsets. More specifically, the present disclosure is related to methods to perform dynamic uniformity correction for foveated imaging in VR and AR displays.

### Related Art

Current techniques for dynamic uniformity compensation in VR and AR headsets make use of eye-tracking techniques that follow the pupil location of a viewer to adjust for the natural non-uniformity in a virtual reality display, in real time. However, this approach involves heavy computational resources (e.g., memory and processing power) in a short expanse of time. This poses an undue burden in the computational capabilities of the headset device, even when the eye-tracking technique can be sufficiently fast and accurate. Some approaches may simplify the problem by using a mean uniformity value for multiple pupil locations. However, this simplistic approach may not render a foveated image with adequate quality.

### SUMMARY

In a first embodiment, a computer-implemented method includes identifying an eyeball position within an image frame in a display of a headset for use in a virtual reality or augmented reality application, wherein the display includes multiple pixels in a two-dimensional array. The computer-implemented method includes forming a filter for the two-dimensional array, the filter being centered on the eyeball position within the image frame, and having a width, collecting a calibration frame for the two-dimensional array, the calibration frame indicative of a uniformity map for multiple pupil locations given the eyeball position within the image frame, generating a filtered map associated with the eyeball position within the image frame, using the filter for the two-dimensional array and the calibration frame, obtaining a uniformity correction factor for a pixel in the display corresponding to the eyeball position within the image frame, based on the filtered map, and generating an eyeball uniformity map including the uniformity correction factor for multiple pixels in the display.

In a second embodiment, a system includes a memory storing instructions and one or more processors configured to execute the instructions to cause the system to perform operations. The operations include to identify an eyeball position within an image frame in a display of a headset for use in a virtual reality or augmented reality application, wherein the display includes multiple pixels in a two-dimensional array, to form a filter for the two-dimensional array, the filter being centered on the eyeball position within the image frame, and having a width, and to collect a calibration frame for the two-dimensional array, the calibration frame indicative of a uniformity map for multiple pupil locations given the eyeball position within the image frame. The operations also include to generate a filtered map associated with the eyeball position within the image frame, using the filter for the two-dimensional array and the calibration frame, to obtain a uniformity correction factor for a pixel in the display corresponding to the eyeball position within the image frame, based on the filtered map, and to generate an eyeball uniformity map including the uniformity correction factor for multiple pixels in the display.

In a third embodiment, a non-transitory, computer-readable medium storing instructions which, when executed by a processor in a computer, cause the computer to perform a method. The method includes identifying an eyeball position within an image frame in a display of a headset for use in a virtual reality or augmented reality application, wherein the display includes multiple pixels in a two-dimensional array. The method also includes forming a filter for the two-dimensional array, the filter being centered on the eyeball position within the image frame, and having a width, and collecting a calibration frame for the two-dimensional array, the calibration frame indicative of a uniformity map for multiple pupil locations given the eyeball position within the image frame. The method also includes generating a filtered map associated with the eyeball position within the image frame, using the filter for the two-dimensional array and the calibration frame, obtaining a uniformity correction factor for a pixel in the display corresponding to the eyeball position within the image frame, based on the filtered map, and generating an eyeball uniformity map including the uniformity correction factor for multiple pixels in the display.

In yet other embodiments, a system includes a first means to store instructions and a second means to execute the instructions to cause the system to perform a method. The method includes identifying an eyeball position within an image frame in a display of a headset for use in a virtual reality or augmented reality application, wherein the display includes multiple pixels in a two-dimensional array. The method also includes forming a filter for the two-dimensional array, the filter being centered on the eyeball position within the image frame, and having a width, and collecting a calibration frame for the two-dimensional array, the calibration frame indicative of a uniformity map for multiple pupil locations given the eyeball position within the image frame. The method also includes generating a filtered map associated with the eyeball position within the image frame, using the filter for the two-dimensional array and the calibration frame, obtaining a uniformity correction factor for a pixel in the display corresponding to the eyeball position within the image frame, based on the filtered map, and generating an eyeball uniformity map including the uniformity correction factor for multiple pixels in the display.

### BRIEF DESCRIPTION OF THE DRAWINGS

FIG. 1 illustrates an architecture for use of a VR/AR headset, according to some embodiments.

FIG. 2 illustrates a geometrical relation between a gaze angle, a pupil location, and an eyeball location for a viewer of a VR/AR headset, according to some embodiments.

FIG. 3 illustrates a non-uniformity distribution of pixels in a display for multiple pupil locations and a fixed eyeball location, according to some embodiments.

FIG. 4 illustrates a calibration frame obtained by scanning a pupil location over an image display for a given eyeball position (e.g., gaze center), according to some embodiments.

FIG. 5 illustrates the construction of an eyeball uniformity map using a filter and a calibration frame for multiple eyeball locations in a display, according to some embodiments.

FIG. 6 illustrates a comparison of different uniformity maps obtained for a fixed pupil location with eyeball uniformity maps for three different pixel colors, according to some embodiments.

FIG. 7 illustrates an eyeball uniformity map including a foveated area, according to some embodiments.

FIG. 8 is a flow chart illustrating steps in a method for providing dynamic uniformity compensation in a VR/AR headset, according to some embodiments.

FIG. 9 is a block diagram illustrating an exemplary computer system with which a VR/AR headset, and the method of FIG. 8 can be implemented, according to some embodiments.

In the figures, elements having the same or similar reference numerals include the same or similar features, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure. Embodiments as disclosed herein should be considered within the scope of features and other embodiments illustrated in Appendix I, filed concurrently herewith.

Embodiments as disclosed herein exploit the concept that for a foveated image, non-uniformity display correction may be performed based on the eyeball location, rather than on the instantaneous pupil location of the viewer. This is possible because the information as to where the gaze center is located may be obtained for each value of the pupil location. Typically, multiple pupil locations may correspond to the same eyeball location (e.g., gaze center), and therefore the frequency of refreshment for the non-uniformity calculation is smaller, and in some cases much smaller than the update frequency of a pupil location. In some embodiments, a weighted mean based on eccentricity is used to incorporate areas of the display that are projected on the viewer fovea. Such a shift in the approach for non-uniformity correction substantially relaxes the constraints on eyeball tracking requirements for virtual reality headsets.

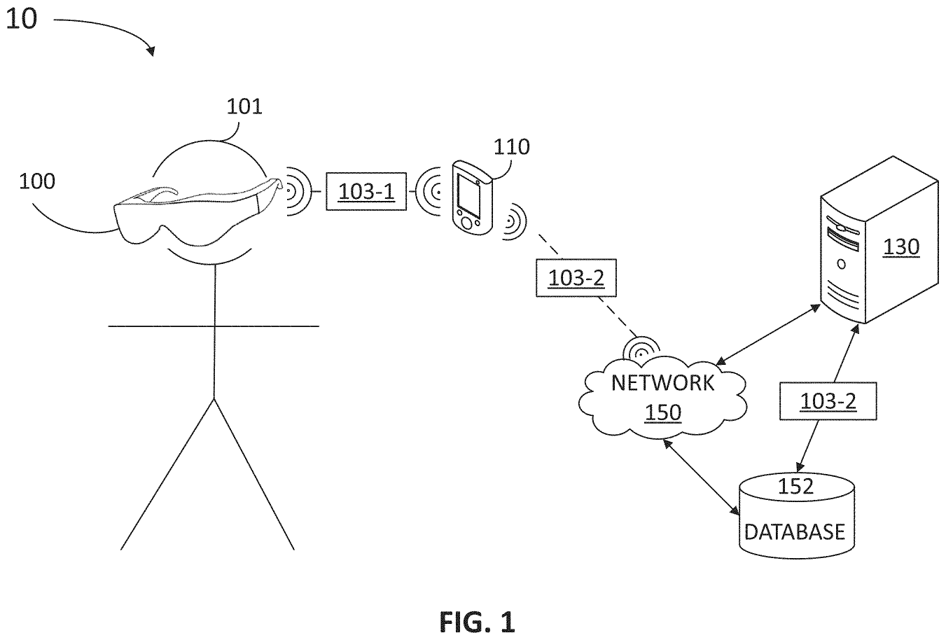

FIG. 1 illustrates an architecture 10 for use of a VR/AR headset 100, according to some embodiments. A user 101 may also have a mobile device 110 paired to VR/AR headset 100. Mobile device 110 and VR/AR headset 100 may communicate wirelessly with one another and may also be communicatively coupled with a remote server 130 and a database 152, via a network 150. Datasets 103-1, 103-2 and 103-3 (hereinafter, collectively referred to as “datasets 103”) may be transmitted between the different devices involved in network 150, as shown. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

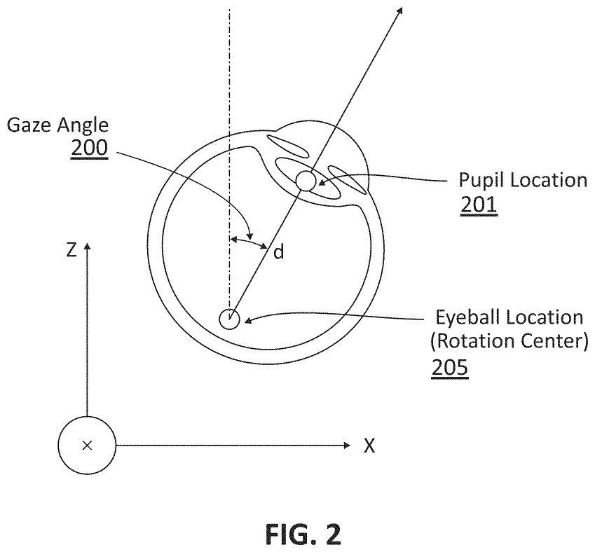

FIG. 2 illustrates a geometrical relation between a gaze angle 200, a pupil location 201, and an eyeball location 205 for a viewer of a VR/AR headset, according to some embodiments. Equations 1.1 and 1.2 express the coordinates of a pupil location vector (xₚ, yₚ):

xₚ=d·tan(θ) (1.1)

yₚ=d·tan(ϕ) (1.2)

Wherein θ and ϕ are the projection of gaze angle 200 on the XZ and the YZ planes, respectively (wherein the YZ plane cuts into the plane of the figure). While the figure illustrates a specific choice of coordinates relative to a viewer's eye, this is for illustrative purposes only, and any other choice of reference frame would be consistent with the present disclosure.

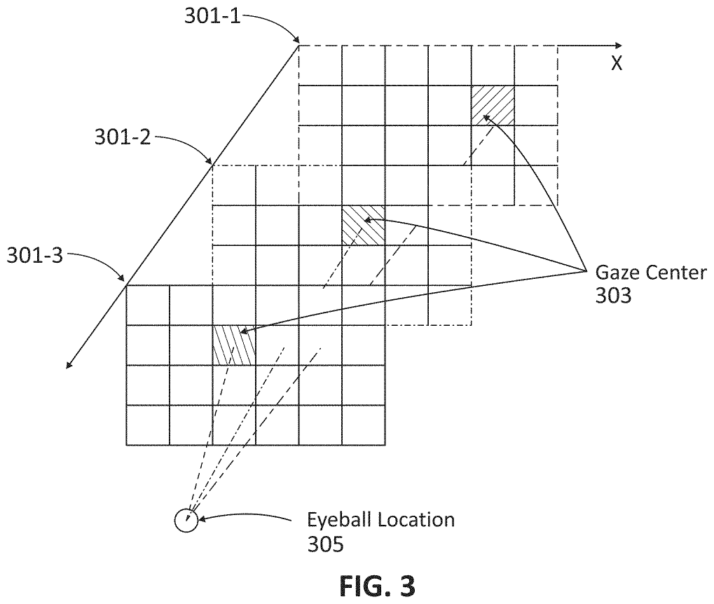

FIG. 3 illustrates a non-uniformity distribution of pixels in a display for multiple pupil locations and a fixed eyeball location, according to some embodiments. For a given eyeball location, a viewer sees a display non-uniformity for different pupil locations 301-1, 301-2, and 301-3 (hereinafter, collectively referred to as “pupil locations 301”). The display non-uniformity is a variation of light intensity perceived by the eye at a given pupil location 301 and depends also on whether the light corresponds to a red, green, or blue pixel. Typically, it is desirable that at least a foveated region of each map be sufficiently uniform to guarantee image quality and improve viewer experience. The foveated region of any given image frame is substantially independent of pupil location 301, as long as the eyeball location 305 is fixed. A gaze center 303 is indicative of eyeball location 305. Accordingly, it is found that correction of image non-uniformity for each eyeball location 305 may be sufficient to provide a high quality foveated image to the viewer.

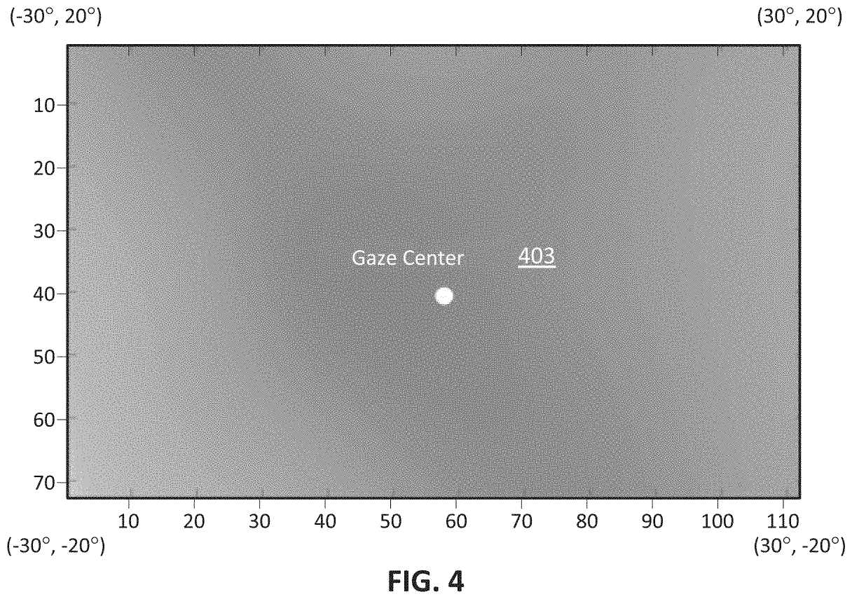

FIG. 4 illustrates a calibration frame obtained by scanning a pupil location over an image display for a given eyeball position (e.g., gaze center 403), according to some embodiments. The calibration frame is a 2D map associating a field of view (FOV) angle (e.g., between −30° to +30° horizontally, and −20° to +20° vertically) to each pupil location for a given gaze center 403 (e.g., the center of the display, at position (0,0)).

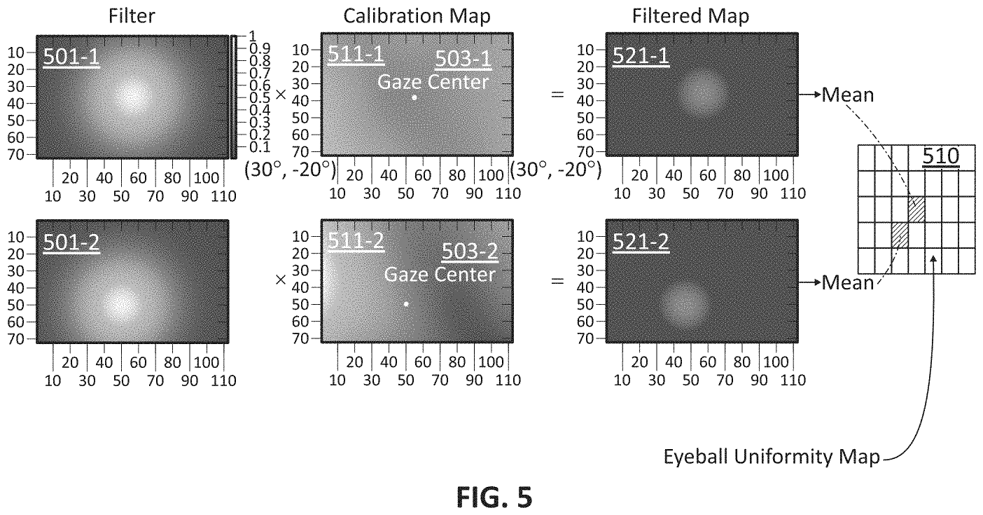

FIG. 5 illustrates the construction of an eyeball uniformity map 510 using a filter (e.g., filters 501-1 and 501-2, hereinafter, collectively referred to as “filters 501”) and a calibration frame (e.g., calibration frames 511-1 and 511-2, hereinafter collectively referred to as “calibration frames 511”) for multiple eyeball locations in a display, according to some embodiments.

Filters 501 may include a two-dimensional function having a width to represent an eccentricity weight. In some embodiments, the width is determined by a foveated area from the viewer's eye projected on the headset display. In some embodiments, the filter is a 2D Gaussian filter wherein the width is the sigma (e.g., variance) of the distribution. The specific filter used in the filter is not limiting of different embodiments consistent with the present disclosure. Other examples may include a Lorentzian filter, a Voigt profile, a top-hat profile, or even a Sinc profile.

Calibration frames 511 may be measured for each eyeball location of a given viewer. Gaze centers 503-1 and 503-2 (hereinafter, collectively referred to as “gaze centers 503”) are also illustrated. Accordingly, calibration frames 511 may be obtained for each of the pixel positions in the headset display, each pixel position being representative of a viewer's eyeball location. A direct multiplication of the filter and the calibration frame results in a filtered map (e.g., filtered maps 521-1 and 521-2, hereinafter, collectively referred to as “filtered maps 521”). A simple average of all the pixels in filtered maps 521 may be the value used in eyeball uniformity map 510 corresponding to a pixel centered in the eyeball location.

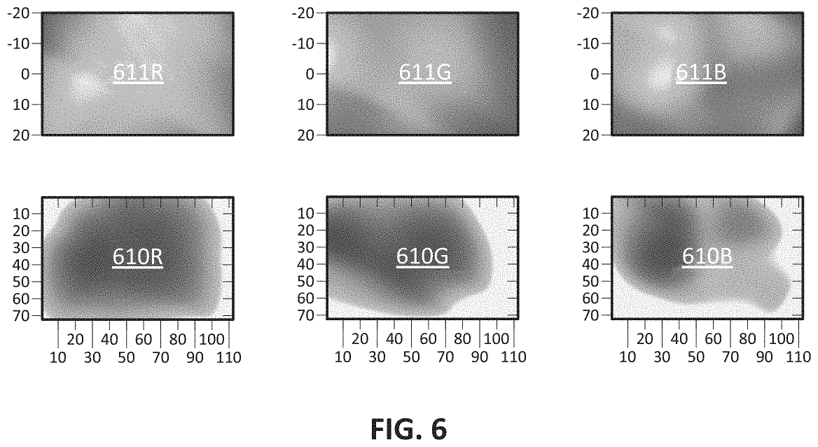

FIG. 6 compares different uniformity maps 610R, 610G, and 610B (hereinafter, collectively referred to as “uniformity maps 610”) obtained for a fixed pupil location with eyeball uniformity maps for three different pixel colors (e.g., Red, R, Green, G and Blue, B), according to some embodiments. The top three maps 611R, 611G, and 611B (hereinafter, collectively referred to as “non-uniformity maps 611”) in the first row are the non-uniformity maps obtained for red, green, and blue pixels in the headset display, with an eyeball position set at the origin (0,0). Uniformity maps 610 are the eyeball uniformity maps for the red, green, and blue pixels in the display, using a Gaussian filter with a sigma covering approximately 10° of the headset display.

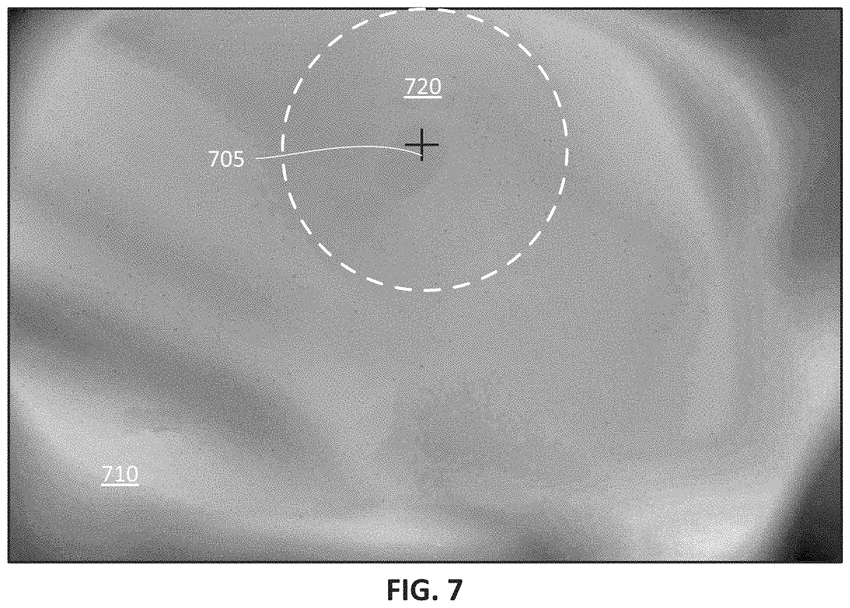

FIG. 7 illustrates an eyeball uniformity map 710 including a foveated area 720, according to some embodiments. Eyeball uniformity map 710 indicates an almost homogeneous correction factor for the foveated portion of the display for an eyeball location 705.

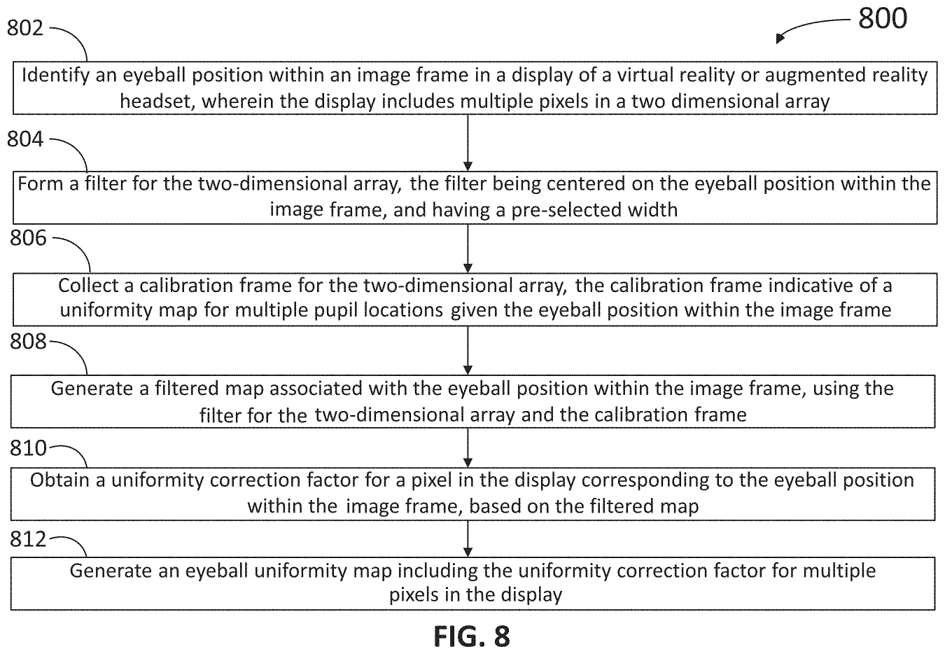

FIG. 8 is a flow chart illustrating steps in a method 800 for providing dynamic uniformity compensation in a VR/AR headset, according to some embodiments. The VR/AR headset may include a display including multiple pixels and a controller to adjust the intensity of each of the pixels via software commands stored in a memory and executed by a processor. A method consistent with the present disclosure may include at least one of the steps in method 800, or two or more steps in method 800 performed in a different order, simultaneously, quasi-simultaneously, or overlapping in time.

Step 802 includes identifying an eyeball position within an image frame in a display of a VR/AR headset, wherein the display includes multiple pixels in a two-dimensional array.

Step 804 includes forming a filter for the two-dimensional array, the filter being centered on the eyeball position within the image frame, and having a pre-selected width. In some embodiments, step 804 includes selecting the width based on a projection of the image frame on a fovea of a user of the VR/AR headset.

Step 806 includes collecting a calibration frame for the two-dimensional array, the calibration frame indicative of a uniformity map for multiple pupil locations given the eyeball position within the image frame.

Step 808 includes generating a filtered map associated with the eyeball position within the image frame, using the filter for the two-dimensional array and the calibration frame.

Step 810 includes obtaining a uniformity correction factor for a pixel in the display corresponding to the eyeball position within the image frame, based on the filtered map. In some embodiments, step 810 includes generating an average of pixel values from the filtered map.

Step 812 includes generating an eyeball uniformity map including the uniformity correction factor for multiple pixels in the VR/AR display. In some embodiments, step 812 includes updating the eyeball uniformity map upon identifying a change in the eyeball position within the image frame. In some embodiments, step 812 includes adjusting an intensity of light emitted by each of the pixels in the display based on the eyeball uniformity map.

### Hardware Overview

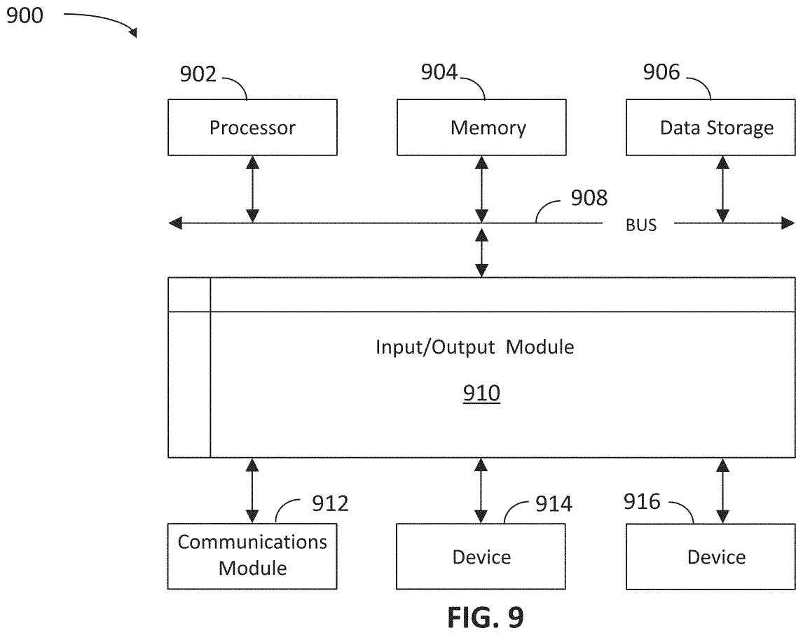

FIG. 9 is a block diagram illustrating an exemplary computer system 900 with which a VR/AR headset, and method 800 can be implemented, according to some embodiments. In certain aspects, computer system 900 may be implemented using hardware or a combination of software and hardware, either in a dedicated server, or integrated into another entity, or distributed across multiple entities. Computer system 900 may include a desktop computer, a laptop computer, a tablet, a phablet, a smartphone, a feature phone, a server computer, or otherwise. A server computer may be located remotely in a data center or be stored locally.

Computer system 900 includes a bus 908 or other communication mechanism for communicating information, and a processor 902 coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, e.g., one or more modules of computer program instructions encoded on a computer-readable medium for execution by, or to control the operation of, the computer system 900, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled with bus 908 for storing information and instructions. Computer system 900 may be coupled via input/output module 910 to various devices. Input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, input/output module 910 is configured to connect to a plurality of devices, such as an input device 914 and/or an output device 916. Exemplary input devices 914 include a keyboard and a pointing device, e.g., a mouse or a trackball, by which a consumer can provide input to the computer system 900. Other kinds of input devices 914 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 916 include display devices, such as an LCD (liquid crystal display) monitor, for displaying information to the consumer.

According to one aspect of the present disclosure, wearable devices can be implemented, at least partially, using a computer system 900 in response to processor 902 executing one or more sequences of one or more instructions contained in memory 904. Such instructions may be read into memory 904 from another machine-readable medium, such as data storage device 906. Execution of the sequences of instructions contained in main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires forming bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

The subject technology is illustrated, for example, according to various aspects described below. Various examples of aspects of the subject technology are described as numbered claims (claim 1, 2, etc.) for convenience. These are provided as examples, and do not limit the subject technology.

In one aspect, a method may be an operation, an instruction, or a function and vice versa. In one aspect, a claim may be amended to include some or all of the words (e.g., instructions, operations, functions, or components) recited in either one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the user technology, the disclosure, the present disclosure, other variations thereof and alike are for convenience only and do not imply that a disclosure relating to such phrase(s) is essential to the user technology or that such disclosure applies to all configurations of the user technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the user technology, and are not referred to in connection with the interpretation of the description of the user technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the user technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the user matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can, in some cases, be excised from the combination, and the described combination may be directed to a subcombination or variation of a subcombination.

The user matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described user matter requires more features than are expressly recited in each claim. Rather, as the claims reflect, inventive user matter lies in less than all features of a single disclosed configuration or operation. The claims are hereby incorporated into the detailed description, with each claim standing on its own as a separately described user matter.

The claims are not intended to be limited to the aspects described herein, but are to be accorded the full scope consistent with the language claims and to encompass all legal equivalents. Notwithstanding, none of the claims are intended to embrace user matter that fails to satisfy the requirements of the applicable patent law, nor should they be interpreted in such a way.

What is claimed is:

1. A computer-implemented method, comprising:
identifying an eyeball position within an image frame in a display of a headset for use in a virtual reality or augmented reality application, wherein the display includes multiple pixels in a two-dimensional array;
forming a filter for the two-dimensional array, the filter being centered on the eyeball position within the image frame, and having a width;
collecting a calibration frame for the two-dimensional array, the calibration frame indicative of a uniformity map for multiple pupil locations given the eyeball position within the image frame;
generating a filtered map associated with the eyeball position within the image frame, using the filter for the two-dimensional array and the calibration frame;
obtaining a uniformity correction factor for a pixel in the display corresponding to the eyeball position within the image frame, based on the filtered map; and
generating an eyeball uniformity map including the uniformity correction factor for multiple pixels in the display.

2. The computer-implemented method of claim 1, wherein identifying an eyeball position within an image frame comprises identifying a pupil location provided by an eye-tracker module, and determining a gaze direction based on a vergence of two pupils from a viewer.

3. The computer-implemented method of claim 1, wherein identifying an eyeball position within an image frame comprises identifying a setting configuration of the headset for a viewer.

4. The computer-implemented method of claim 1, wherein forming a filter for the two-dimensional array comprises selecting the width based on a projection of the image frame on a fovea of a viewer of the headset.

5. The computer-implemented method of claim 1, wherein collecting a calibration frame comprises adjusting the calibration frame based on the eyeball position.

6. The computer-implemented method of claim 1, wherein obtaining a uniformity correction factor for a pixel in the display comprises generating an average of pixel values from the filtered map.

7. The computer-implemented method of claim 1, further comprising updating the eyeball uniformity map upon identifying a change in the eyeball position within the image frame.

8. The computer-implemented method of claim 1, further comprising adjusting an intensity of light emitted by each of the pixels in the display based on the eyeball uniformity map.

9. The computer-implemented method of claim 1, wherein collecting a calibration frame for the two-dimensional array comprises collecting three calibration frames including a red pixel calibration frame, a green pixel calibration frame, and a blue pixel calibration frame.

10. The computer-implemented method of claim 1, further comprising adjusting an intensity of a light emitted by the pixels in the two-dimensional array according to the eyeball uniformity map.

11. A system, comprising:
a memory storing multiple instructions; and
one or more processors configured to execute the instructions to cause the system to:
identify an eyeball position within an image frame in a display of a headset for use in a virtual reality or augmented reality application, wherein the display includes multiple pixels in a two-dimensional array,
form a filter for the two-dimensional array, the filter being centered on the eyeball position within the image frame, and having a width,
collect a calibration frame for the two-dimensional array, the calibration frame indicative of a uniformity map for multiple pupil locations given the eyeball position within the image frame,
generate a filtered map associated with the eyeball position within the image frame, using the filter for the two-dimensional array and the calibration frame,
obtain a uniformity correction factor for a pixel in the display corresponding to the eyeball position within the image frame, based on the filtered map, and
generate an eyeball uniformity map including the uniformity correction factor for multiple pixels in the display.

12. The system of claim 11, wherein to identify an eyeball position within an image frame the one or more processors execute instructions to identify a pupil location provided by an eye-tracker module, and to determine a gaze direction based on a vergence of two pupils from a viewer.

13. The system of claim 11, wherein to identify an eyeball position within an image frame the one or more processors execute instructions to identify a setting configuration of the headset for a viewer.

14. The system of claim 11, wherein to form a filter for the two-dimensional array the one or more processors execute instructions to select the width based on a projection of the image frame on a fovea of a viewer of the headset.

15. The system of claim 11, wherein to collect a calibration frame the one or more processors execute instructions to adjust the calibration frame based on the eyeball position.

16. A non-transitory, computer-readable medium storing instructions which, when executed by a processor in a computer, cause the computer to perform a method, the method comprising:
identifying an eyeball position within an image frame in a display of a headset for use in a virtual reality or augmented reality application, wherein the display includes multiple pixels in a two-dimensional array;
forming a filter for the two-dimensional array, the filter being centered on the eyeball position within the image frame, and having a width;
collecting a calibration frame for the two-dimensional array, the calibration frame indicative of a uniformity map for multiple pupil locations given the eyeball position within the image frame;
generating a filtered map associated with the eyeball position within the image frame, using the filter for the two-dimensional array and the calibration frame;
obtaining a uniformity correction factor for a pixel in the display corresponding to the eyeball position within the image frame, based on the filtered map; and
generating an eyeball uniformity map including the uniformity correction factor for multiple pixels in the display.

17. The non-transitory, computer-readable medium of claim 16, further comprising instructions to identify a pupil location provided by an eye-tracker module, and to determine a gaze direction based on a vergence of two pupils from a viewer.

18. The non-transitory, computer-readable medium of claim 16, further comprising instructions to identify a setting configuration of the headset for a viewer.

19. The non-transitory, computer-readable medium of claim 16, further comprising instructions to select the width based on a projection of the image frame on a fovea of a viewer of the headset.

20. The non-transitory, computer-readable medium of claim 16, further comprising instructions to adjust the calibration frame based on the eyeball position.
